(19) United States
(12) Patent Application Publication
(10) Pub. No.: US 2013/0301972 A1
(43) Pub. Date: Nov. 14, 2013

(54) BI-ANNULAR-SHAPED BEARING WITH ANTI-PLAY CHARACTERISTICS

(71) Applicant: David PENG, Kaohsiung City (TW)

(72) Inventor: David PENG, Kaohsiung City (TW)

(73) Assignee: CHAIR MAN HI-TECH CO., LTD., Kaohsiung City (TW)

(21) Appl. No.: 13/467,649

(22) Filed: May 9, 2012

(51) Int. Cl. F16C 27/04; F16C 33/58; F16C 19/08

(52) U.S. Cl. 384/513; 384/535

(57) ABSTRACT

A simplified bi-annular-shaped bearing with anti-play characteristics has an inner race, an outer race, at least one ring groove and a roller-shaped limiting set, The races can relatively rotate. The ring groove is configured on the periphery of the inner race or the inner ring surface of the outer race. The roller-shaped limiting set is configured on at least one position of the outer race or inner race, and comprises rigid balls, elastic supporting components and positioning members. The outer race or inner race is configured with a radial housing part to hold the roller-shaped limiting set. The elastic supporting component is to elastically push the rigid ball toward the end opening configured on the radial housing part, so that it will go into and contact against the ring groove.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a bearing, and more particularly to an innovative structural design of a simplified bi-annular-shaped bearing with anti-play characteristics.

2. Description of Related Art Including Information Disclosed Under 37 CFR 1.97 and 37 CFR 1.98.

There are many different kinds of bearings seen in the present market. If they are classified by usages and specifications, there may be nearly ten thousand types. But if classified by functions and relative motion modes, bearings can be mainly divided into rolling bearings and sliding bearings.

The present invention particularly aims to improve the structure of rolling bearings. The conventional structure of a rolling bearing generally comprises an inner race ring, an outer race ring, rolling elements (such as balls or rollers) and a retainer. In short, several rolling elements are installed between the two race rings, the rolling elements are spaced to avoid contact with each other, and the retainer is used to maintain the smooth rolling state of the rollers. The components and assembly processes of a conventional rolling bearing is quite complicated. Generally, a preset quantity of the first group of rolling elements shall be firstly placed into the outer race ring, then the inner race ring is attached to limit the first group of rolling elements, and then a preset quantity of the second group of rolling elements shall be placed into the preset position on the other side of the inner race ring. In the end, a retainer shall be installed to limit the second group of rolling elements. Such an assembly process of a conventional rolling bearing is obviously complicated.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention has the main characteristics that a roller-shaped limiting set is configured on at least one position on the outer race or inner race, so as to achieve an axial limiting and anti-play function when the inner and outer races rotate relatively. Comparing to the prior-art designs, such an innovative design uses the rigid ball of the roller-shaped limiting set to go into and contact against the ring groove, and correspondingly, the elastic supporting component of the roller-shaped limiting set can elastically push the rigid ball to generate a pre-pressure effect, so that the fitting state of the inner and outer races can achieve an axial limiting and anti-play function, and maintain smooth radial rotation between the inner and outer races. Therefore, the present invention has provided an innovative bi-annular-shaped bearing with anti-play function, simplified structure, and high economic benefit to meet the diversified needs of user ends and application environments.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the overall shape of the bi-annular-shaped bearing of the present invention.

FIG. 2 is an exploded perspective view of the structure of the bi-annular-shaped bearing of the present invention.

FIG. 3 is a sectional view of the bi-annular-shaped bearing of the present invention.

FIG. 4 is a sectional view of the bi-annular-shaped bearing of the present invention fitted on an axle shaft.

FIG. 5 is a sectional view of a second embodiment of the bi-annular-shaped bearing of the present invention.

FIG. 6 is a sectional view of a third embodiment of the bi-annular-shaped bearing of the present invention.

FIG. 7 is a sectional view of the inner race of the present invention configured with a radial housing part and holding a roller-shaped limiting set.

### DETAILED DESCRIPTION OF THE INVENTION

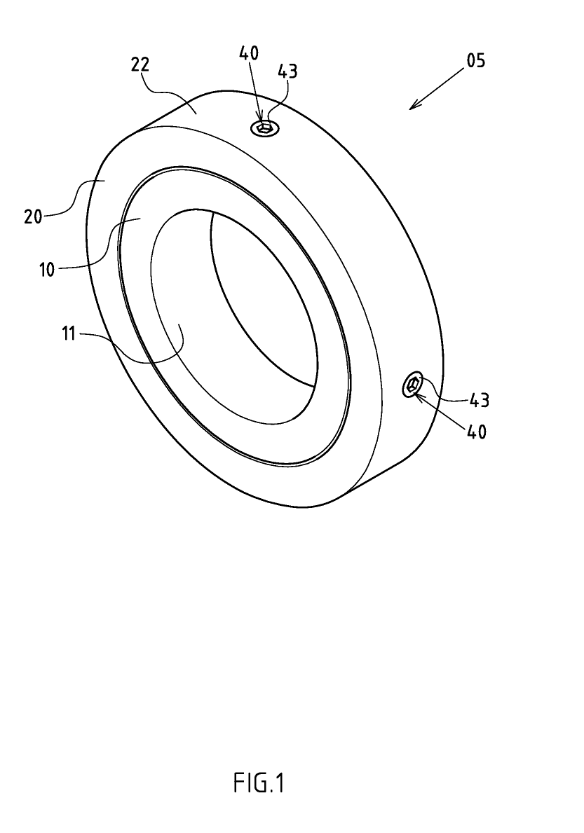

FIGS. 1 to 4 depict a preferred embodiment of the present invention of a simplified bi-annular-shaped bearing with anti-play characteristics. However, such an embodiment is descriptive only, and is not intending to limit the scope of patent application.

The bi-annular-shaped bearing 05 comprises an inner race 10, in the shape of a round ring. The inner race 10 comprises an axle hole 11 and a periphery 12, wherein the axle hole 11 can be fitted with an axle shaft A (only marked in FIG. 4).

An outer race 20 is fitted around the periphery 12 of the inner race 10. The outer race 20 comprises an inner ring surface 21 and an outer ring surface 22, wherein the inner ring surface 21 contacts against the periphery 12 of the inner race 10 and can relatively rotate.

At least one ring groove 30 is configured on the periphery 12 of the inner race 10 or the inner ring surface 21 of the outer race 20 in an indented profile, and the shape of the ring groove 30 can be in any profile of semi-circle, trapezoid, or V-shape. As an example, the ring groove 30 in the present embodiment is configured on the periphery 12 of the inner race 10.

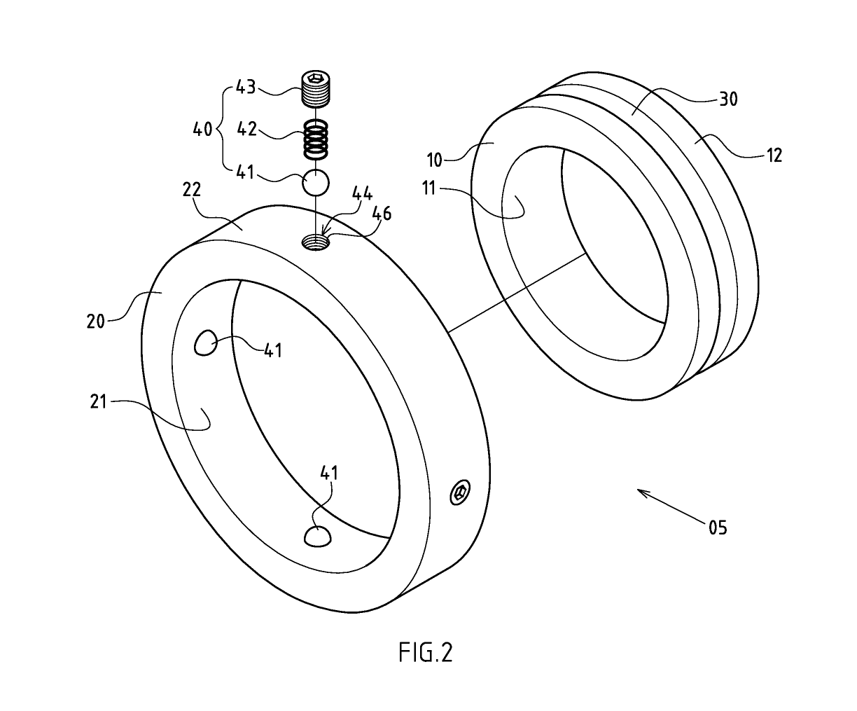

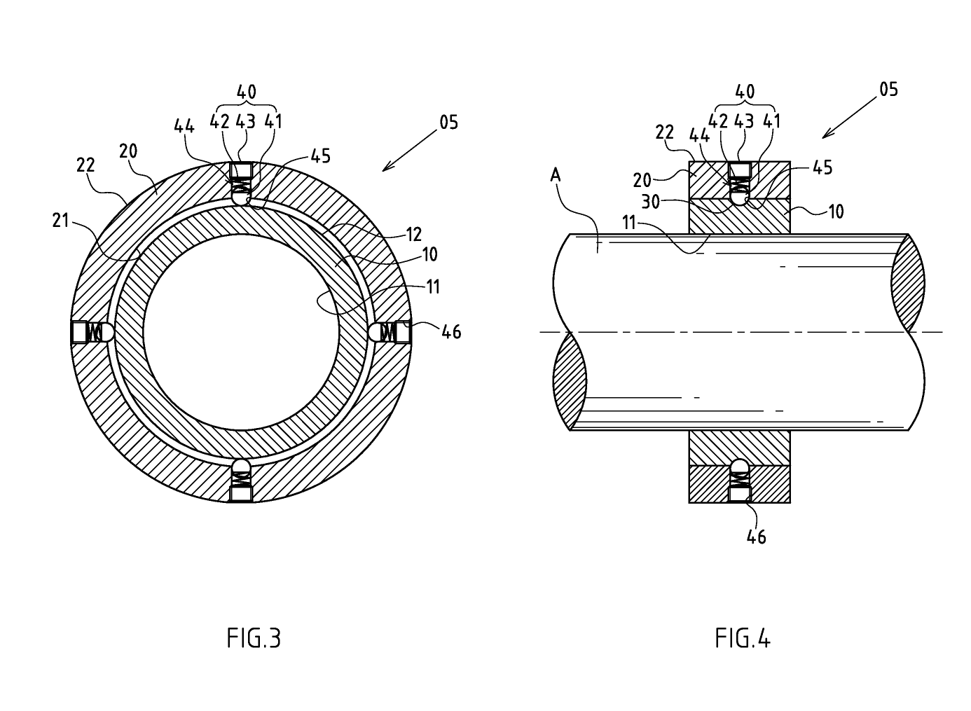

At least one roller-shaped limiting set 40 is configured on at least one position of the outer race 20 (or inner race 10). The roller-shaped limiting set 40 comprises a rigid ball 41, an elastic supporting component 42 and a positioning member 43, wherein the outer race 20 (or inner race 10) is correspondingly configured with a radial housing part 44 to hold the roller-shaped limiting set 40, and the radial housing part 44 has an end opening 45 for one side of the rigid ball 41 to be able to go into the ring groove 30 (see FIGS. 2, 3). The elastic supporting component 42 is to push the rigid ball 41 toward the end opening 45, and the positioning member 43 is fitted tightly on the other end of the radial housing part 44, to limit the rigid ball 41 and the elastic supporting component 42.

Based on such a structure to use the rigid ball 41 of the roller-shaped limiting set 40 to go into and contact against the ring groove 30, the fitting state of the inner and outer races 10, 20 can effectively achieve an axial limiting and anti-play function, and maintain smooth radial rotation between the inner and outer races 10, 20.

Detailed structure of the above combination is as follows. The end opening 45 of the radial housing part 44 is configured in the shape of a reducing opening. The elastic supporting component 42 of the roller-shaped limiting set 40 is configured in the shape of a spiral spring, and the positioning member 43 is configured in the shape of a sunk screw, and correspondingly, the other side of the radial housing part 44 is configured with a female screw thread 46 for the positioning member 43 in the shape of a sunk screw to fit into.

FIGS. 2 and 3 show a practical embodiment of the present invention. When the roller-shaped limiting set 40 is in a plural configuration, it is configured along the radial direction of the outer race 20 (or inner race 10) in a spaced distribution, and the rigid ball 41 of each roller-shaped limiting set 40 goes into the same ring groove 30.

Referring to FIG. 4, the axle hole 11 of the inner space 10 configured on the bi-annular-shaped bearing 05 can fit with the axle shaft A, so that the inner race 10 is fixed and the outer race 20 is rotary. Through the roller-shaped limiting set 40, an anti-play function can be achieved when the axle shaft A rotates. Or, referring to FIG. 5, the outer race 20 is configured with only one roller-shaped limiting set 40. Such a structure can also achieve an anti-play function.

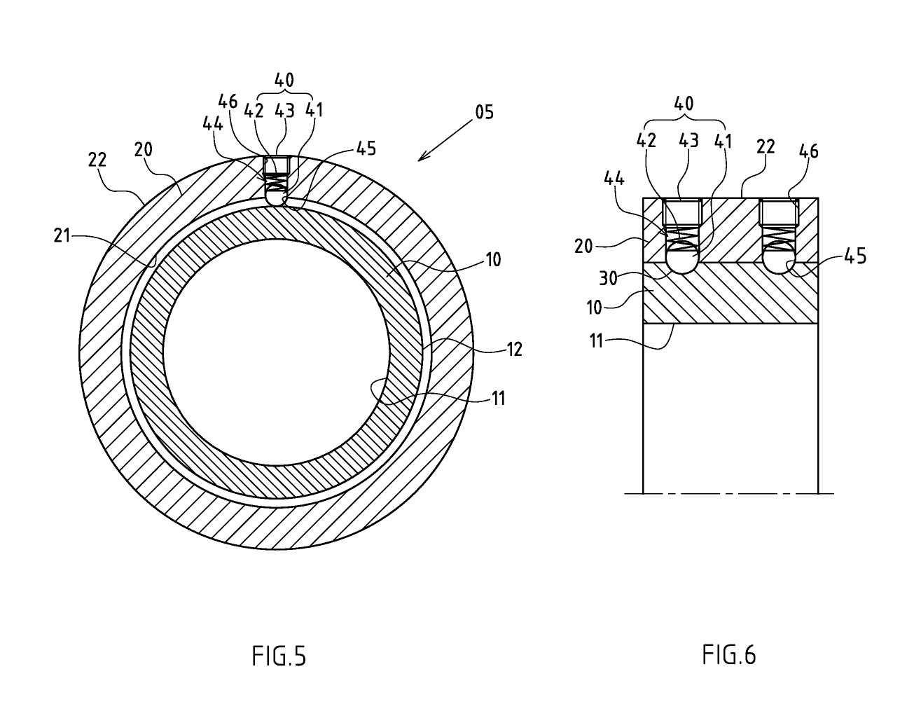

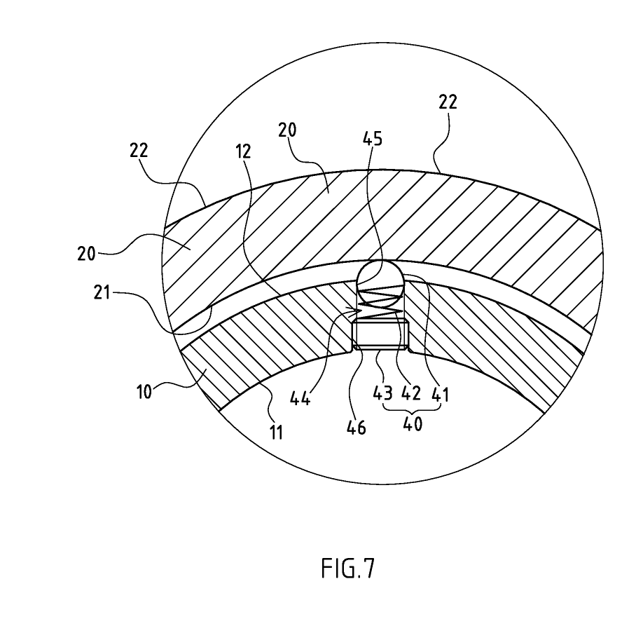

In addition, referring to FIG. 6, which is another practical embodiment of the present invention, when the roller-shaped limiting set 40 is also in a plural configuration, it is configured along the axial direction of the outer race 20 (or inner race 10) in a spaced distribution, and correspondingly the rigid ball 41 of the roller-shaped limiting set 40 goes into different ring grooves 30. Such a structure can enhance the smoothness of radial rotation between the inner and outer races 10, 20, and meanwhile improve the anti-play function.

FIG. 7 depicts an embodiment with the radial housing part 44 configured on the inner race 10, and correspondingly the roller-shaped limiting set 40 is held inside the radial housing part 44. But in such an embodiment, the ring groove 30 is configured on the inner ring surface 21 of the outer race 20.

Based on the above structural design, the present invention operates as follows:

Referring to FIGS. 2 to 4, when the bi-annular-shaped bearing 05 is fixed on the axle shaft A, the elastic supporting component 42 configured on the roller-shaped limiting set 40 can elastically push the rigid ball 41 toward the end opening 45, so that the rigid ball 41 can go into the ring groove 30 of the inner race 10 (or outer race 20). As the elastic supporting component 42 can provide an elastic pushing force to push the rigid ball 41, the bi-annular-shaped bearing 05 will have a pre-pressing effect. So, when the axle shaft A rotates, the fitting state of the inner and outer races 10, 20 can provide an axial limiting and anti-play function, and maintain smooth radial rotation between the inner and outer races 10, 20, and consequently, the accuracy during running of the axle shaft A can be effectively enhanced.

1. A simplified bi-annular-shaped bearing with anti-play characteristics, comprising:
an inner race, in the shape of a round ring; the inner race comprises an axle hole and a periphery;
an outer race, fitted around the periphery of the inner race; the outer race comprises an inner ring surface and an outer ring surface, wherein the inner ring surface contacts against the periphery of the inner race and can relatively rotate;
at least one ring groove, configured on the periphery of the inner race or the inner ring surface of the outer race;
at least one roller-shaped limiting set, configured on at least one position of the outer race or inner race; the roller-shaped limiting set comprises a rigid ball, an elastic supporting component and a positioning member, wherein the outer race or inner race is correspondingly configured with a radial housing part to hold the roller-shaped limiting set, and the radial housing part has an end opening for one side of the rigid ball to be able to go into the ring groove; the elastic supporting component is to push the rigid ball toward the end opening, and the positioning member is fitted tightly on the other end of the radial housing part to limit the rigid ball and the elastic supporting component;
based on such a structure to use the rigid ball of the roller-shaped limiting set to go into and contact against the ring groove, the fitting state of the inner and outer races can effective achieve an axial limiting and anti-play function, and maintain smooth radial rotation between the inner and outer races.

2. The device defined in claim 1, wherein, when the roller-shaped limiting set is in a plural configuration, it is configured along the radial direction of the inner race or outer race in a spaced distribution and the rigid ball of each roller-shaped limiting set goes into the same ring groove.

3. The device defined in claim 1, wherein, when the roller-shaped limiting set is in a plural configuration, it is configured along the axial direction of the inner race or outer race in a spaced distribution, and correspondingly the rigid ball of the roller-shaped limiting set goes into different ring grooves.

4. The device defined in claim 1, wherein the section of the indented ring groove configured on the periphery of the inner race or the inner ring surface of the outer race is in any profile of semi-circle, trapezoid or V-shape.

5. The device defined in claim 1, wherein the end opening of the radial housing part is configured in the shape of a reducing opening; the elastic supporting component of the roller-shaped limiting set is configured in the shape of a spiral spring, and the positioning member is configured in the shape of a sunk screw, and correspondingly, the other side of the radial housing part is configured with a female screw thread for the positioning member in the shape of a sunk screw to fit into.
